(19) United States
(12) Patent Application Publication
(10) Pub. No.: US 2026/0307389 A1
(43) Pub. Date: Oct. 8, 2026

(54) LIQUID EJECTION UNIT AND METHOD FOR MANUFACTURING LIQUID EJECTION UNIT

(71) Applicant: CANON KABUSHIKI KAISHA, Tokyo (JP)

(72) Inventor: HIKARU SUGIMOTO, Kanagawa (JP)

(21) Appl. No.: 19/553,589

(22) Filed: Mar. 2, 2026

(30) Foreign Application Priority Data
Apr. 2, 2025 (JP) 2025-061182

(51) Int. Cl. B41J 2/16; B41J 2/14; C09D 5/16; C09D 183/12; C09J 5/00

(52) U.S. Cl. CPC B41J 2/1623; B41J 2/14072; B41J 2/14088; B41J 2/1601; C09D 5/1675; C09D 183/12; C09J 5/00; B41J 2002/14491

(57) ABSTRACT

A liquid ejection unit comprising a liquid ejection chip and a wiring substrate connected to the liquid ejection chip, wherein the liquid ejection chip contains: an ejection element that generates energy for ejecting liquid; a liquid ejection substrate on which the ejection element is provided; and an electrode part provided on the liquid ejection substrate for driving the ejection element; the wiring substrate is electrically connected to the electrode part; the liquid ejection unit has a non-conductive adhesive that bonds the electrode part on the liquid ejection substrate and the wiring substrate; the non-conductive adhesive contains a filler; a surface free energy of the filler is 55 dyne/cm or less; and a surface free energy of the electrode part is 65 to 150 dyne/cm.

### BACKGROUND

### Field of the Technology

The present disclosure relates to a liquid ejection unit and a method for manufacturing the liquid ejection unit.

### Description of the Related Art

Devices such as inkjet printers are equipped with a liquid ejection unit. In the case of an inkjet printer, text and images can be formed by ejecting minute amounts of ink using an inkjet recording head equipped with a liquid ejection unit. The liquid ejection unit includes a liquid ejection chip having ejection nozzles for ejecting liquid, and a wiring substrate electrically connected to the liquid ejection chip by an electrical connection part.

Furthermore, the electrical connection part is embedded by a sealing part to maintain electrical reliability. This sealing part is formed by curing a liquid sealing material. The material used for sealing by this method is called Non-Conductive Paste (NCP), and hereinafter the sealing material will be referred to as NCP material.

The NCP material has the property of being cured by heat, and is filled between a liquid ejection chip 15 and a wiring substrate 14 as shown in FIG. 1. The method of electrical connection is as follows. First, after aligning the liquid ejection chip 15 and the wiring substrate 14, a load is applied from the top in the figure, and an NCP material 11 is scraped out from the contact surfaces, bringing pads 12 of the wiring substrate 14 into contact with electrode parts (pads) 13 of the liquid ejection chip 15. Next, the NCP material 11 is cured by applying heat while the position is constrained by the load, and the electrical connection is maintained by a curing shrinkage force.

In this process, the NCP material needs to have stable coating properties on the substrate and maintain its shape between the application of load and heating, requiring appropriate viscosity adjustment.

Japanese Patent Laid-Open No. 2006-297916 discloses a method for adjusting the viscosity by adding a silicone filler to the NCP material.

### SUMMARY

However, according to the inventors' investigations, the silicone filler described in Japanese Patent Laid-Open No. 2006-297916 tends to aggregate inside the liquid sealing material when the amount of the filler is increased. As a result, the filler gets trapped at the contact parts of the liquid ejection chip and the wiring substrate, causing a decrease in energization quantity or energization disruption. Therefore, when a larger amount of filler is added to increase the viscosity and improve the shape retention property of the NCP material, it becomes difficult to stably contact the pads 12 of the wiring substrate and the electrode parts 13 of the liquid ejection chip of the liquid ejection unit.

A generally known technique for suppressing filler aggregation involves surface-treating the filler with a silane coupling agent or the like. However, making the filler hydrophilic makes it susceptible to swelling and dissolution by water-based ink, so it cannot be applied to sealing materials for inkjet heads.

The present disclosure provides a liquid ejection unit that, when using an NCP material containing a filler, can suppress filler aggregation and achieve stable electrical connection, and also provides a method for manufacturing the liquid ejection unit.

The present disclosure relates to a liquid ejection unit comprising a liquid ejection chip and a wiring substrate connected to the liquid ejection chip, wherein the liquid ejection chip comprises: an ejection element that generates energy for ejecting liquid; a liquid ejection substrate on which the ejection element is provided; and an electrode part provided on the liquid ejection substrate for driving the ejection element; the wiring substrate is electrically connected to the electrode part; the liquid ejection unit has a non-conductive adhesive that bonds the electrode part on the liquid ejection substrate and the wiring substrate; the non-conductive adhesive contains a filler; a surface free energy of the filler is 55 dyne/cm or less; and a surface free energy of the electrode part is 65 to 150 dyne/cm.

Features of the present disclosure will become apparent from the following description of embodiments with reference to the attached drawings. The following description of embodiments is described by way of example.

### BRIEF DESCRIPTION OF THE DRAWINGS

FIG. 1 illustrates electrical connection using an NCP material.

FIGS. 2A and 2B are schematic diagrams showing the basic configuration of a liquid ejection head.

FIGS. 3A and 3B are schematic diagrams showing the basic configuration of a liquid ejection unit.

FIGS. 4A and 4B are manufacturing process diagrams of the liquid ejection unit.

FIG. 5 is a manufacturing process diagram of the liquid ejection unit.

FIG. 6 schematically illustrates the immersion of the liquid ejection chip in a surfactant.

### DESCRIPTION OF THE EMBODIMENTS

In the present disclosure the notations “from XX to YY” and “XX to YY” representing a numerical value range signify, unless otherwise specified, a numerical value range that includes the lower limit and the upper limit of the range, as endpoints. In a case where numerical value ranges are described in stages, the upper limits and the lower limits of the respective numerical value ranges can be combined arbitrarily. In the present disclosure, for instance, a wording such as “at least one selected from the group consisting of XX, YY and ZZ” encompasses XX, YY and ZZ, a combination of XX and YY, a combination of XX and ZZ, a combination of YY and ZZ, and a combination of XX, YY and ZZ.

Hereinafter, embodiments of the present disclosure will be described with reference to the drawings. The following embodiments are not intended to limit the present disclosure, and not all combinations of features described in the embodiments are necessarily essential to the solutions disclosed in the present application. The same reference numerals are given to the same components.

### Liquid Ejection Unit

Before describing the characteristic configuration and manufacturing method of the liquid ejection unit according to the present embodiment, the basic configuration and manufacturing method of the liquid ejection unit will be described with reference to the drawings. In the present embodiment, the case of a liquid ejection unit provided in an inkjet recording head (liquid ejection head) mounted on an inkjet printer will be described as an example.

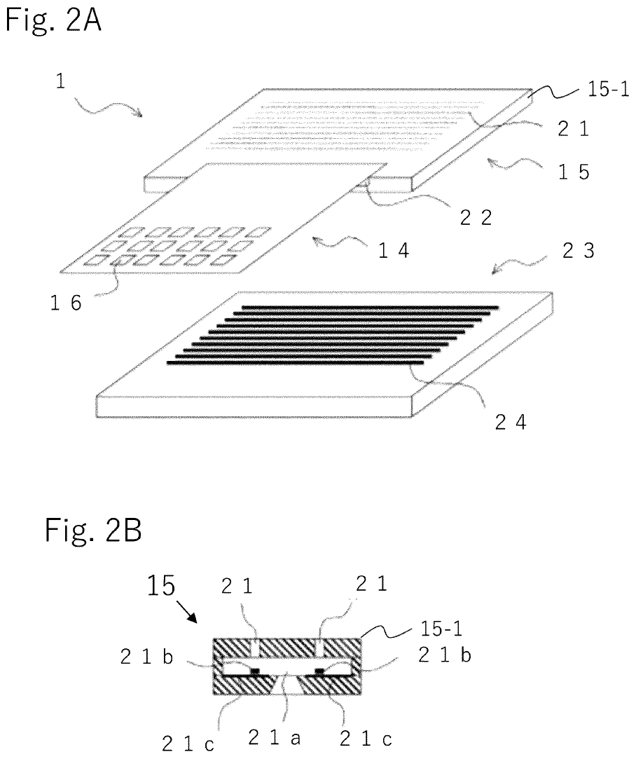

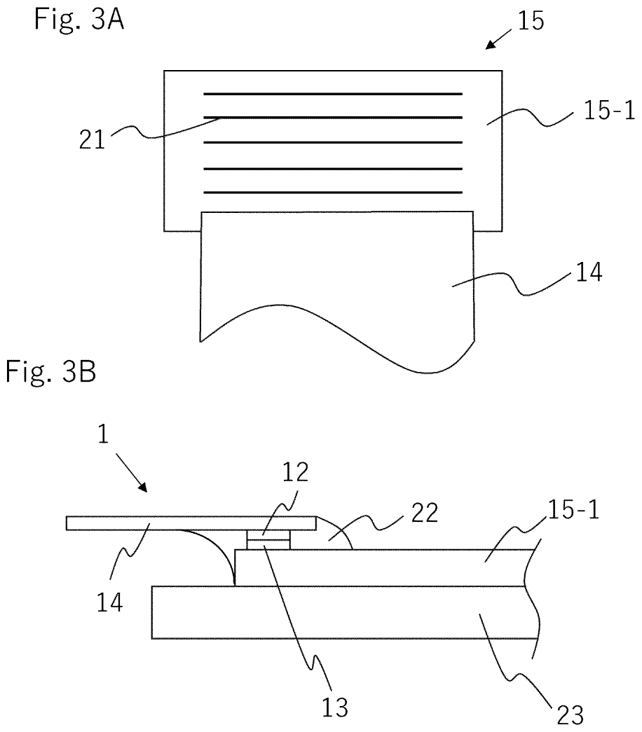

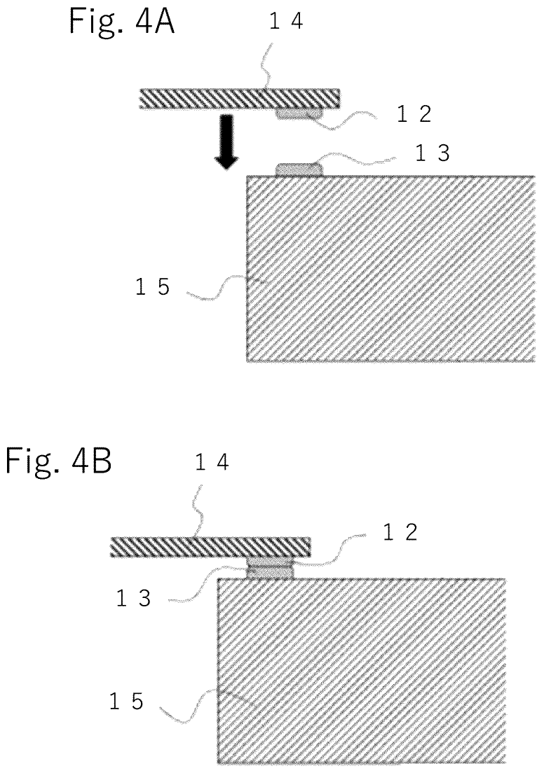

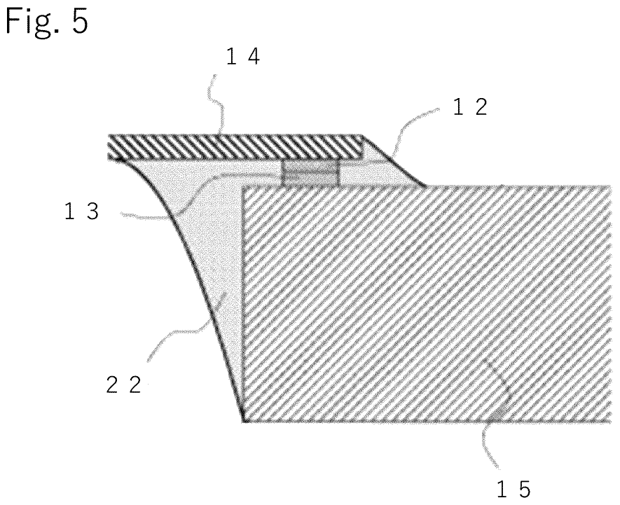

FIGS. 2A and 2B are schematic diagrams showing the basic configuration of a liquid ejection head equipped with a liquid ejection unit. FIG. 2A is a partially exploded perspective view of the liquid ejection head, and FIG. 2B is a schematic cross-sectional view showing the vicinity of ejection ports 21 from which liquid is ejected. FIG. 2B merely shows an example of the structure near the ejection ports 21, and various structures can be adopted. FIGS. 3A and 3B are schematic diagrams showing the basic configuration of a liquid ejection unit 1. FIG. 3A is a partial plan view of the liquid ejection unit 1, and FIG. 3B is a partial side view of the liquid ejection unit 1. FIGS. 4A, 4B, and 5 are manufacturing process diagrams of the liquid ejection unit, showing the vicinity of the electrical connection part in a schematic cross-sectional view.

The liquid ejection unit 1 includes a liquid ejection chip 15 and a wiring substrate 14 connected to the liquid ejection chip 15. The liquid ejection unit 1 includes, for example, the liquid ejection chip 15 having a liquid ejection substrate 15-1 in which a plurality of ejection ports 21 is formed, and the wiring substrate 14 that is electrically connected to the liquid ejection chip 15. The liquid ejection unit 1 configured in this way is joined to a support member (base substrate) 23 that supports the liquid ejection chip 15. Therefore, the liquid ejection head has the liquid ejection unit 1 and a support member (base substrate) 23 that supports the liquid ejection chip 15 in the liquid ejection unit 1.

The liquid ejection chip 15 includes ejection elements 21b that generate energy for ejecting liquid, the liquid ejection substrate 15-1 on which the ejection elements 21b are provided, and electrode parts (pads) 13 provided on the liquid ejection substrate 15-1 for driving the ejection elements 21b.

For example, the liquid ejection chip 15 includes a liquid flow path 21a on the liquid ejection substrate 15-1, which leads to the ejection ports 21 and has a liquid supply port. Furthermore, the liquid ejection chip 15 also includes a plurality of ejection elements (electrothermal conversion elements) 21b that eject the liquid, which was heated by converting electrical signals sent from the wiring substrate 14 into thermal energy, from the ejection ports 21. In addition, the liquid ejection chip 15 also includes wiring 21c that is electrically connected to each ejection element 21b.

The liquid ejection chip 15 has electrode parts (pads) 13 provided on the liquid ejection substrate 15-1 for sending electrical signals to the ejection elements 21b to drive the ejection elements 21b.

The wiring substrate 14 is electrically connected to the electrode parts 13. That is, the wiring 21c is electrically connected to the wiring on the wiring substrate 14.

The wiring substrate 14 has a plurality of electrical wirings and includes a plurality of connection portions 16 that are electrically connected to the device body (the device body of the inkjet printer). This wiring substrate 14 is composed of a flexible printed circuit board or the like. The support member 23 includes a plurality of flow paths 24 for supplying ink stored in an ink tank (not shown) to the liquid flow path 21a of the liquid ejection chip 15.

With the liquid ejection head configured as described above, where an electrical signal is sent from the device body to the ejection element 21b through the wiring substrate 14 and via the electrode part 13 and the wiring 21c, the ejection element 21b converts the electrical signal into thermal energy, and the ink is heated. This generates air bubbles in the ink, and the pressure of the air bubbles causes the ink to be ejected from the ejection port 21.

The liquid ejection unit 1 has a non-conductive adhesive 22 that bonds the electrode parts 13 on the liquid ejection substrate 15-1 and the wiring substrate 14 (FIGS. 2A and 3B). The liquid ejection unit 1 preferably has the non-conductive adhesive 22 that bonds the electrode parts 13 on the liquid ejection substrate 15-1 and the electrode parts 12 on the wiring substrate 14. As shown in FIG. 3B, the non-conductive adhesive 22 may be attached to the electrode part 13 and the area surrounding the electrode part 13 on the liquid ejection substrate 15-1. The non-conductive adhesive 22 serves as a sealing portion that seals the electrical connection portions (preferably the electrode parts 13 and the electrode parts 12) between the liquid ejection substrate 15-1 and the wiring substrate 14.

In the present disclosure, the non-conductive adhesive contains a filler, the surface free energy of the filler is 55 dyne/cm or less, and the surface free energy of the electrode part is 65 dyne/cm to 150 dyne/cm.

Because the surface free energy of the filler and the electrode part is within the above ranges, the filler repels the electrode part appropriately, preventing the filler from remaining and aggregating on the electrode part. Therefore, stable electrical connection is considered possible.

The surface free energy of the filler is preferably 30 dyne/cm or less, and more preferably 25 dyne/cm or less. Since it is preferable for the filler to be hydrophobic, the lower limit is not particularly limited. The surface free energy of the filler is, for example, 0 dyne/cm to 55 dyne/cm, preferably 0 dyne/cm to 30 dyne/cm, and more preferably 0 dyne/cm to 25 dyne/cm. The surface free energy of the filler may also be, for example, 10 dyne/cm to 55 dyne/cm, preferably 10 dyne/cm to 30 dyne/cm, and more preferably 10 dyne/cm to 25 dyne/cm.

The surface free energy of the electrode part is preferably 75 dyne/cm to 130 dyne/cm, and more preferably 80 dyne/cm to 120 dyne/cm. Within this range, the repulsion between the filler and the electrode part becomes more appropriate, further suppressing filler aggregation and resulting in more stable electrical connection.

The surface free energy of the liquid ejection substrate is preferably 70 dyne/cm or less. Where the surface free energy of the liquid ejection substrate is within this range, the filler is less likely to repel the liquid ejection substrate, and the filler is more likely to be selectively positioned on the substrate rather than on the electrode part. Therefore, the electrical connection becomes more stable. The surface free energy of the liquid ejection substrate is preferably 50 dyne/cm to 70 dyne/cm, and more preferably 55 dyne/cm to 65 dyne/cm.

It is preferable that the electrode part be coated with a surfactant. The coating layer of the surfactant makes it easier to control the surface free energy of the electrode part within the above range.

The film thickness of the coating layer created by the surfactant on the electrode part is, for example, 1 nm to 150 nm, preferably 10 nm to 140 nm, more preferably 15 nm to 130 nm, even more preferably 20 nm to 125 nm, and still more preferably 25 nm to 120 nm. Within these ranges, the electrical connection by the electrode part becomes better.

The surfactant is not particularly limited as long as it can adjust the surface free energy of the electrode parts to the above range. For example, at least one selected from the group consisting of silicone-based surfactants and cellulose-based surfactants can be used. Preferably, it is at least one selected from the group consisting of PEG-dimethicone and etherified cellulose. PEG-dimethicone is a compound in which some of the methyl groups of dimethicone are substituted with polyethylene glycol. Etherified cellulose is cellulose that has been etherified, and examples thereof include METOLOSE (product name) manufactured by Shin-Etsu Chemical Co., Ltd.

PEG-dimethicone is represented by, for example, the following formula (A), and etherified cellulose is represented by, for example, the following formula (B). In (A), x and y are the molar ratios of the siloxane structure, and the structure in parentheses with y attached can exist randomly within the molecule. Also, n represents the number of repeating units of the ether structure (average degree of polymerization) and is preferably 3 to 32. In formula (B), n is the number of repeating units, and the range of peak molecular weight described hereinbelow is preferable.

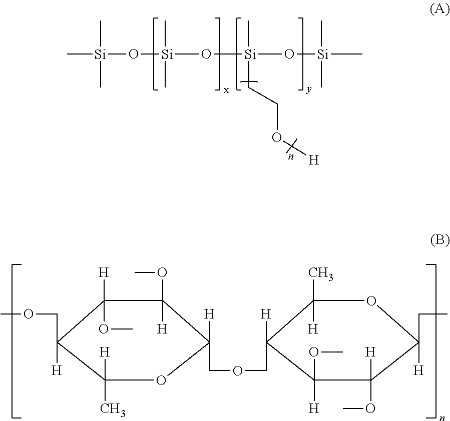

The surfactant preferably has Si in the main chain and at least one functional group selected from the group consisting of —OH, —COOH, and —NH₃ at at least one terminal end. Specifically, silicone-based surfactants are preferred. —OH is more preferred as the functional group. It is believed that the bond with the electrode part is strengthened by Si.

The peak molecular weight of the surfactant is, for example, 100 to 3000, preferably 200 to 2000.

The surfactant preferably contains a repeating unit having an ether structure. The average number of repeating units is preferably 3 to 32, more preferably 3 to 12, and even more preferably 3 to 10. The average number of repeating units is represented by n in formula (A) and is the average degree of polymerization. The repeating unit having an ether structure is more preferably a structure to which polyethylene glycol is added.

### Method for Manufacturing Liquid Ejection Unit

Next, a method for manufacturing the liquid ejection unit 1 will be described. The liquid ejection unit 1 is manufactured, for example, by first fabricating the liquid ejection chip 15 and the wiring substrate 14 separately, and then electrically connecting the liquid ejection chip 15 and the wiring substrate 14. Afterward, the electrical connection parts thereof are embedded by a sealing part. Below, a step of providing the electrical connection parts and a step of providing the sealing part by using the non-conductive adhesive 22 will be described.

The method for manufacturing the liquid ejection unit preferably includes: a step of preparing the liquid ejection chip 15 and the wiring substrate 14; a step of hydrophilizing the electrode parts (pads) 13 at the liquid ejection chip 15; and a step of bringing the hydrophilized electrode parts (pads) 13 at the liquid ejection chip 15 into contact with the electrode parts (pads) 12 of the wiring substrate 14 to enable electrical connection, and bonding the parts with the non-conductive adhesive 22 to obtain the liquid ejection unit.

The liquid ejection chip 15 is provided with electrode parts (pads) 13 for electrical connection, and the wiring substrate 14 is similarly provided with electrode parts (pads) 12 for electrical connection. That is, the wiring substrate has electrode parts that can be electrically connected to the electrode parts of the liquid ejection chip. As shown in FIGS. 3A and 3B, the liquid ejection chip 15 and the wiring substrate 14 can be electrically connected by welding the electrode parts (pads) 12 and the electrode parts (pads) 13 together using the non-conductive adhesive 22 while the parts are in contact.

In the present embodiment, the welded portions of the electrode parts (pads) 12 and the electrode parts (pads) 13 correspond to the electrical connection parts. The material for the electrode parts (pads) 12 and the electrode parts (pads) 13 can be a metal with low electrical resistance, and a material with high joining reliability is desirable. Examples include gold, platinum, copper, and the like. Gold is suitable as a material for the electrode parts (pads) because of low resistance and high corrosion resistance thereof.

The film thickness (height) of the electrode parts (pads) 12 and the electrode parts (pads) 13 is, for example, 5 μm to 100 μm, preferably 10 μm to 30 μm.

The step of hydrophilizing the electrode parts (pads) 13 in the liquid ejection chip 15 may be performed so that the surface free energy of the electrode parts is within the range described above (e.g., 65 dyne/cm to 150 dyne/cm). Preferably, so that the surface free energy of the liquid ejection substrate 15-1 is within the above range. Hydrophilization treatment can include, for example, treatment with the above-mentioned surfactant or surface treatment with plasma, but treatment with a surfactant is preferred.

In the step of hydrophilizing the electrode parts (pads) 13 in the liquid ejection chip 15, it is preferable to immerse the electrode parts (pads) 13 at the liquid ejection chip 15 in the above-mentioned surfactant, and it is preferable to immerse only the electrode parts (pads) 13 and not the liquid ejection substrate 15-1.

The immersion time is not particularly limited as it varies depending on the surfactant used, but examples include 10 sec to 800 sec, or 20 sec to 200 sec.

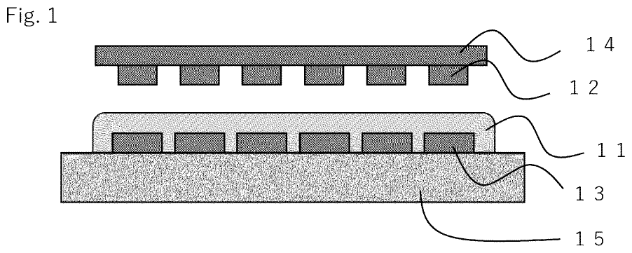

Regarding the connection method for electrically connecting the liquid ejection chip 15 and the wiring substrate 14, as shown in FIGS. 4A and 4B, the electrical connection pads 12 and 13 are brought into close proximity. Then, a method is used in which a curable resin (NCP material (reference numeral 11 in FIG. 1)), which becomes the non-conductive adhesive 22, is applied around the pads 12 and 13 to connect the pads. In this case, the portions where the electrode parts (pads) are connected correspond to the electrical connection parts.

After the electrical connection parts have been provided as described above, in order to suppress short circuits and deterioration of the electrical connection parts, the electrical connection parts are embedded by the non-conductive adhesive 22, which is a sealing part, thereby providing insulation protection to the electrical connection parts (FIG. 5). Specifically, after the NCP material is supplied to the regions including the electrical connection parts, the NCP material cures, thereby providing the non-conductive adhesive 22 to embed the electrical connection part.

As the NCP material to be used for the non-conductive adhesive 22, a curable liquid resin material can be suitably used. That is, various materials can be used as the NCP material, as long as the material can be cured from a liquid state by some kind of action. Specific examples of the non-conductive adhesive include at least one selected from the group consisting of epoxy resin, acrylic resin, silicone resin, urethane resin, epoxy acrylate resin, imide resin, amide resin, and the like.

Furthermore, various curing methods can be used, such as two-component mixing curing by mixing a curing agent, thermal curing by heating, UV curing by ultraviolet irradiation, and curing using a moisture effect. For example, by using a thermosetting epoxy resin, the non-conductive adhesive 22 can be easily provided because the liquid epoxy resin can be cured by heating after being supplied.

### NCP Material

The NCP material 11 for forming the non-conductive adhesive 22 is preferably applied between the liquid ejection chip 15 and the wiring substrate 14 and cured by heat. Therefore, it is necessary that this material could be applied with an appropriate film thickness, be sufficiently cured by heat, and maintain the shape thereof while the electrode parts (pads) 12 and electrode parts (pads) 13 are in contact.

First, a curable resin compound is used as the base. The type of resin is not particularly limited as long as the resin can be cured by heat or light, but suitable examples include epoxy resins, acrylic resins, silicone resins, urethane resins, epoxy acrylate resins, imide resins, and amide resins. Among these, epoxy resins are most preferable from the viewpoint of resistance to reaction inhibition and durability to components in the ink.

Next, a curing agent is added simultaneously to promote the curing of the NCP material. The type of curing agent is not particularly limited, but examples include thiols, imidazoles, aliphatic polyamines, polyaminoamides, polymercaptans, aromatic polyamines, acid anhydrides, phenol resins, and dicyandiamide.

The amount of curing agent is, for example, 10 parts by mass to 120 parts by mass, or 20 parts by mass to 100 parts by mass, per 100 parts by mass of epoxy resin.

Furthermore, a curing accelerator may be added to enhance the properties of the curing agent. The type of curing accelerator is not particularly limited, as long as it has a higher reactivity than the material used in the curing agent. Specific examples include tertiary amines, imidazole compounds, and phosphorus compounds.

Finally, to stabilize the coating property and shape retention property, a filler as a solid component is added to the NCP material 11. The filler is used to adjust the viscosity and thixotropy. Examples of solid components include glass fillers, aluminum nitride, silicone fillers, and silica powder. The filler is preferably at least one selected from the group consisting of silicone fillers and silica. The silicone filler contains silicone resin.

In terms of physical properties, for the reasons listed in (1) to (3) below, the more hydrophobic the filler, the better, and the degree of hydrophobicity is not particularly limited.
(1) Difficult to dissolve in water-based ink, resulting in high durability
(2) High dispersibility in resins, preventing aggregation
(3) Less likely to be adsorbed to the hydrophilic substrate surface described hereinbelow

Other additives such as ion trapping agents, colorants, and adhesion promoters may also be added.

The content of the filler is preferably 1 part by mass to 20 parts by mass, more preferably 2 parts by mass to 10 parts by mass, and even more preferably 2 parts by mass to 7 parts by mass, per to 100 parts by mass of the resin (preferably epoxy resin) in the non-conductive adhesive. The number average particle diameter of the filler is preferably 0.1 μm to 5.0 μm, more preferably 0.1 μm to 2.5 μm, even more preferably 0.1 μm to 2.0 μm, and still more preferably 1.0 μm to 2.0 μm.

The electrode parts (pads) 12 for electrical connection on the wiring substrate 14 are preferably the same as the electrode parts (pads) 13 on the liquid ejection chip 15. The electrode part 12 is, for example, a metal, preferably gold. The surface free energy of the electrode part 12 is, for example, 65 dyne/cm to 150 dyne/cm, preferably 75 dyne/cm to 130 dyne/cm, and more preferably 80 dyne/cm to 120 dyne/cm. The electrode part 12 can be subjected to a hydrophobic treatment with a surfactant, similar to the electrode part 13, and may have a coating layer of the surfactant. The film thickness of the coating layer is, for example, 1 nm to 150 nm, preferably 10 nm to 140 nm.

### EXAMPLES

Examples and Comparative Examples are shown below, but the present disclosure is not limited thereto.

### Example 1

### (1-1) Cutting Out Liquid Ejection Substrate

First, on a silicon wafer serving as the liquid ejection substrate 15-1, ejection ports 21, liquid channels 21a, ejection elements (electrothermal conversion elements) 21b, and wiring 21c electrically connected to the ejection elements were formed (the methods for forming these are well-known techniques, so the explanation thereof is omitted herein). Next, electrode parts (pads) 13 electrically connected to the wiring 21c were attached to the silicon wafer 15-1. At this time, gold was selected as the material for the electrode parts (pads) because it has low electric resistance and high corrosion resistance.

Next, a dicing blade was introduced from the surface of the silicon wafer 15-1 where the electrode parts (pads) 13 were attached, and grooves that did not reach the opposite side were formed. Furthermore, the wafer was cut at positions between the two grooves to obtain the liquid ejection chip 15.

### (1-2) Fabrication of Wiring Substrate 14

The wiring substrate was manufactured by forming electrode parts (pads) 12 on a film and patterning them to achieve the desired line and space dimensions. Gold was selected as the material for the electrode parts (pads) 12.

### (2) Hydrophilization Treatment of Electrode Parts

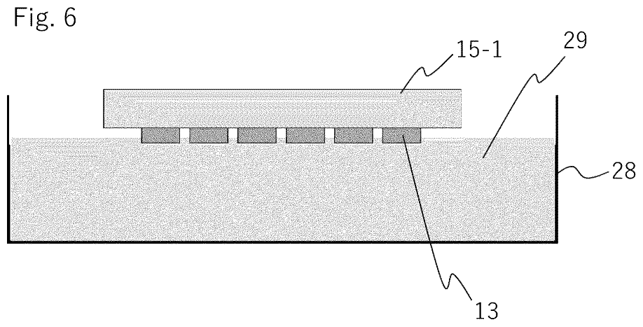

First, PEG-10 dimethicone (manufactured by Shin-Etsu Chemical Co., Ltd.), which is a surfactant 29, was placed as a hydrophilization agent in a petri dish 28, and the liquid ejection chip 15 was immersed with the electrode part (pad) surface facing downwards, as shown in FIG. 6. At this time, the height of the electrode part (pad) 13 was 15 μm, and the immersion depth in the surfactant was adjusted to 7.5 μm. The liquid ejection chip was allowed to stand for 30 sec (dip time) in this state and then was pulled up vertically.

### (3) Evaluation of Liquid Ejection Chip 15

For the hydrophobized liquid ejection chip 15, the film thickness of the coating layer formed by the surfactant was first evaluated. After the treatment with the surfactant, the film thickness was measured using a non-contact film thickness measuring device C13027 (manufactured by Hamamatsu Photonics K.K.). The arithmetic mean value of 10 points was used for the measurement.

A correlation was observed between the surfactant treatment time and the film thickness, showing the film thicknesses described in Tables 2-1 and 2-2 below.

Furthermore, the advancing static water contact angle on the surface of both the electrode part and the substrate was measured using an automatic minimum contact angle meter MCA-4 (manufactured by Kyowa Interface Science Co., Ltd.). The measurement was then repeated using diiodomethane instead of water. Finally, the surface free energy was calculated from the contact angle values of both.

Furthermore, the surface free energy was measured using the same method also after the liquid ejection chip had been retained at room temperature (25° C.) for 72 h after surface modification, and the effect of the retention was confirmed. In this case, the measurements were taken for “surface free energy of the electrode part” and “surface free energy on the substrate”. These definitions are as follows:

### Surface Free Energy of Electrode Part

When no surfactant is coated: Surface free energy of the electrode surface When surfactant is coated: Surface free energy of the surfactant layer on the electrode

### Surface Free Energy of Substrate Part

The surface free energy of the portion on the liquid ejection substrate (liquid ejection chip surface) between the electrodes that is in contact with the NCP material

### Measurement of Surface Free Energy of Filler

The surface free energy of the filler was calculated from the contact angle. The contact angle was measured by the Washburn method. The Washburn method is a method for calculating the contact angle by filling a tube with a filler as a powder and measuring the time and wetting load when a liquid wets the powder from the bottom end of the tube. The surface free energy was calculated from the obtained contact angle. A high-precision surface tensiometer DY-700 (manufactured by Kyowa Interface Science Co., Ltd.) was used as the measuring device. Hexane and n-hexadecane were used as the liquid.

### (4) Application of NCP Material Forming Non-Conductive Adhesive 22

On the substrate fabricated in (3) above, an NCP material containing 50.0% by mass of epoxy resin (828 (manufactured by Mitsubishi Chemical Corporation)), 2.5% by mass of silicone filler (Tospearl 120 (manufactured by Momentive Performance Materials, Inc.)), and 47.5% by mass of acid anhydride (Rikacid MH-700 (manufactured by New Japan Chemical Co., Ltd.)) was applied with a film thickness of 8 μm. Specifically, the NCP material was first filled into a syringe, and a needle (30G-13L) manufactured by Musashi Engineering, Inc. was attached to the tip. Then, the application was performed under the conditions of a pressure of 300 kPa, a needle movement speed of 1.8 mm/s, and a gap of 80 μm between the needle and the substrate.

### (5) Thermocompression Bonding of Materials (Manufacturing of Liquid Ejection Unit)

After applying the NCP material, the electrode parts (pads) of the liquid ejection chip 15 and the electrode parts (pads) of the wiring substrate 14 were aligned and then thermocompression bonded using a flip-chip bonder femto2 (manufactured by Finetech GmbH & Co.), which is a bonding tool. At this time, initially, a load of 160 N was applied for 10 sec in a 40° C. environment to maintain the position. Then, while maintaining the load, the temperature was increased to 200° C. at a rate of 20° C./s, and compression bonding was performed by allowing the system to stand at 200° C. for 5 sec. After that, the temperature and pressure were lowered to room temperature and normal pressure, and then the liquid ejection unit was removed.

### (6) Evaluation of Liquid Ejection Unit (Electrostatic Capacity)

The liquid ejection chip 15 and the wiring substrate 14 were energized, and the charge quantity stored was measured using a measuring device CHECKSUM V12 (manufactured by Newly Tsuchiyama Co., Ltd.). At this time, the charge quantity stored was measured continuously for 60 min, and the average value was used as the result. Furthermore, to confirm the effects of ink durability and retention, the electrostatic capacitance was measured again after subjecting the liquid ejection chip and wiring substrate to the following two conditions.

The evaluation was carried out by performing energization continuously for 60 min and observing the average value of electrostatic capacitance and the presence or absence of energization disruption. Regarding energization disruption, if there was even one instance of disruption during the 60 min, it was determined as “Energization NG”.

Condition 1: Evaluation of Ink Durability (Electrostatic Capacitance after Liquid Contact)

The structure was immersed in ink with the composition shown in Table 1 at 60° C. for 14 days, then naturally dried for 24 h, and then the electrostatic capacitance was measured to evaluate the effect of ink immersion.

TABLE 1
Ink composition used for ink durability evaluation

| Components | Blending ratio |
|---|---|
| Water | 70 wt % |
| Glycerol | 30 wt % |

### Condition 2: Evaluation of Effect of Retention After Surface Modification (Electrostatic Capacitance After 72 h of Retention)

The liquid ejection chip, after completing the previous step (3) Evaluation of Liquid Ejection Chip 15, was allowed to stand at room temperature (25° C.) for 72 h, and then step (4) Application of NCP Material and subsequent steps were performed, and the electrostatic capacitance was measured to evaluate the effect of retention.

### Example 2

The conditions were the same as in Example 1, except that the immersion time (dip time) of the liquid ejection chip in the surfactant in (2) Hydrophilization Treatment of Electrode Parts was changed to 45 sec.

### Example 3

The conditions were the same as in Example 1, except that the immersion time of the liquid ejection chip in the surfactant in (2) Hydrophilization Treatment of Electrode Parts was changed to 60 sec.

### Example 4

The conditions were the same as in Example 1, except that the immersion time of the liquid ejection chip in the surfactant in (2) Hydrophilization Treatment of Electrode Parts was changed to 90 sec.

### Example 5

First, steps up to (3) Evaluation of Liquid Ejection Chip 15 were performed under the same conditions as in Example 2.

Next, an NCP material with a filler having high surface free energy was prepared. First, as a base material, 97 g of a filler-less NCP material, which was the NCP material used in Example 1 with only the silicone filler removed, was prepared and placed in a cup. Next, 10 g of Admafine SO-C5 (manufactured by Admatechs Co., Ltd.), which is a silicone filler, was placed in a plastic container, and plasma treatment was performed under the following conditions.

### Conditions

PDC510, manufactured by Yamato Scientific Co., Ltd. (Conditions) RF output 400 W, RF time 50 sec

Next, 97 g of filler-less NCP material and 3 g of plasma-treated Admafine SO-C5 were mixed by hand and then mixed using a vacuum stirring and defoaming machine at 1200 rpm for 2 min. This mixing was repeated three times to obtain an NCP material with a filler having high surface free energy.

Thereafter, step (4) Application of NCP Material and subsequent steps were carried out under the same conditions as in Example 1.

### Example 6

In (2) Hydrophilization Treatment of Electrode Parts, methyl ether dimethicone PEG-32 (manufactured by Shin-Etsu Chemical Co., Ltd.), which is a surfactant, was selected as the hydrophilic treatment agent. Also, to match the surface free energies of the electrode parts and the substrate to those of Example 2, the immersion time in the surfactant was set to 30 sec. Otherwise, the conditions were the same as in Example 2.

### Example 7

In (2) Hydrophilization Treatment of Electrode Parts, methyl ether dimethicone PEG-3 (manufactured by Shin-Etsu Chemical Co., Ltd.), which is a surfactant, was selected as the hydrophilic treatment agent. Also, to match the surface free energies of the electrode parts (pads) and the substrate to those of Example 2, the immersion time in the surfactant was set to 180 sec. Otherwise, the conditions were the same as in Example 2.

### Example 8

In (2) Hydrophilization Treatment of Electrode Parts, METOLOSE SM (manufactured by Shin-Etsu Chemical Co., Ltd.), which is a surfactant, was selected as the hydrophilic treatment agent. Also, to match the surface free energies of the electrode parts (pads) and the substrate to those of Example 2, the immersion time in the surfactant was set to 180 sec. Otherwise, the conditions were the same as in Example 2.

### Example 9

The conditions were the same as in Example 8, except that the immersion time of the liquid injection chip in the surfactant during (2) Hydrophilization Treatment of Electrode Parts was changed to 600 sec.

### Example 10

In (2) Hydrophilization Treatment of Electrode Parts, plasma treatment was performed under the following conditions without using a surfactant. Otherwise, the conditions were the same as in Example 1.

### Conditions

PDC510, manufactured by Yamato Scientific Co., Ltd. (Conditions) RF output 400 W, RF time 50 sec

### Comparative Example 1

The conditions were the same as in Example 1, except that (2) Hydrophilization Treatment of Electrode Parts was not performed.

### Comparative Example 2

The conditions were the same as in Example 1, except that the immersion time of the liquid injection chip in the surfactant in (2) Hydrophilization Treatment of Electrode Parts was changed to 120 sec.

### Comparative Example 3

The conditions were the same as in Example 1, except that the immersion time of the liquid injection chip in the surfactant in (2) Hydrophilization Treatment of Electrode Parts was changed to 10 sec.

### Comparative Example 4

The conditions were the same as in Example 5, except that the plasma treatment of the silicone filler Admafine SO-C5 was performed under the following conditions.

### Conditions

PDC510, manufactured by Yamato Scientific Co., Ltd. (Conditions) RF output 400 W, RF time 75 sec

The above results are summarized in Tables 2-1 and 2-2.

TABLE 2-1

| | Number | | | | | | | | | |
|---|---|---|---|---|---|---|---|---|---|---|
| | Example | Example | Example | Example | Example | Example | Example | Example | Example | Example |
| | 1 | 2 | 3 | 4 | 5 | 6 | 7 | 8 | 9 | 10 |
| Surface free energy of | 65 | 80 | 120 | 150 | 80 | 80 | 80 | 80 | 150 | 80 |
| electrode parts | | | | | | | | | | |
| (dyne/cm) | | | | | | | | | | |
| Surface free energy of | 52 | 57 | 63 | 70 | 57 | 57 | 57 | 57 | 70 | 57 |
| substrate (dyne/cm) | | | | | | | | | | |
| Dip time/sec | 30 | 45 | 60 | 90 | 45 | 30 | 180 | 180 | 600 | 0 |
| Plasma treatment of | No | No | No | No | No | No | No | No | No | Yes |
| substrate | | | | | | | | | | |
| Surfactant film | 50 | 56 | 70 | 115 | 56 | 120 | 25 | 95 | 140 | — |
| thickness (electrode | | | | | | | | | | |
| part)/nm | | | | | | | | | | |
| Surface free energy | 65 | 80 | 120 | 150 | 80 | 80 | 65 | 80 | 150 | 60 |
| after allowing to stand | | | | | | | | | | |
| for 72 h at room | | | | | | | | | | |
| temperature | | | | | | | | | | |
| (dyne/cm) | | | | | | | | | | |
| Surface free energy of | 24 | 24 | 24 | 24 | 55 | 24 | 24 | 24 | 24 | 24 |
| filler (dyne/cm) | | | | | | | | | | |
| Type of surfactant | PEG | PEG | PEG | PEG | PEG | PEG | PEG | METOLOSE | METOLOSE | None |
| | dime- | dime- | dime- | dime- | dime- | dime- | dime- | | | |
| | thicone | thicone | thicone | thicone | thicone | thicone | thicone | | | |
| Surfactant ether | 10 | 10 | 10 | 10 | 10 | 32 | 3 | 10 | 10 | None |
| structure portion chain | | | | | | | | | | |
| length | | | | | | | | | | |
| Electrostatic | A | A | A | B | B | A | A | A | B | A |
| capacitance | | | | | | | | | | |
| Electrostatic | A | A | A | B | B | B | A | B | B | A |
| capacitance after | | | | | | | | | | |
| contact with liquid | | | | | | | | | | |
| Electrostatic | B | A | A | B | B | A | A | B | C | C |
| capacitance when | | | | | | | | | | |
| using substrate | | | | | | | | | | |
| retained for 72 h | | | | | | | | | | |

TABLE 2-2

| | Compar- | Compar- | Compar- | Compar- |
|---|---|---|---|---|
| | ative | ative | ative | ative |
| Number | Example 1 | Example 2 | Example 3 | Example 4 |
| Surface free | 50 | 200 | 60 | 80 |
| energy of electrode | | | | |
| parts (dyne/cm) | | | | |
| Surface free | 50 | 75 | 50 | 57 |
| energy of substrate | | | | |
| (dyne/cm) | | | | |
| Dip time/sec | 0 | 120 | 10 | 45 |
| Plasma treatment | No | No | No | No |
| of substrate | | | | |
| Surfactant film | — | 190 | 30 | 56 |
| thickness | | | | |
| (electrode part)/ | | | | |
| nm | | | | |
| Surface free | 50 | 200 | 60 | 80 |
| energy after | | | | |
| allowing to stand | | | | |
| for 72 h at room | | | | |
| temperature | | | | |
| (dyne/cm) | | | | |
| Surface free | 24 | 24 | 24 | 60 |
| energy of filler | | | | |
| (dyne/cm) | | | | |
| Type of surfactant | None | PEG | PEG | PEG |
| | | dimeth- | dimeth- | dimeth- |
| | | icone | icone | icone |
| Surfactant ether | None | 10 | 10 | 10 |
| structure portion | | | | |
| chain length | | | | |
| Electrostatic | D | C | C | C |
| capacitance | | | | |
| Electrostatic | D | D | D | D |
| capacitance after | | | | |
| contact with liquid | | | | |
| Electrostatic | D | C | C | C |
| capacitance when | | | | |
| using substrate | | | | |
| retained for 72 h | | | | |

The evaluation results are shown below.

First, in the materials examined this time, since the electrostatic capacitance was 12 pF to 13 pF when adequate conduction was achieved, the ideal average electrostatic capacitance (A) was set to 12 pF or higher. It is also known from the examination that if there are times when the conduction is disrupted, the electrostatic capacitance decreases to 7 pF to 8 pF. Therefore, the desirable electrostatic capacitance (B) was set to 10 pF or higher. Based on these findings, the following ranking was used in this evaluation.
A: No disruption when energizing for 60 min, and the average electrostatic capacitance is 12 pF or higher
B: No disruption when energizing for 60 min, and the average electrostatic capacitance is 10 pF or higher and less than 12 pF
C: No disruption when energizing for 60 min, and the average electrostatic capacitance is less than 10 pF
D: Disruption when energizing for 60 min

### Surface Free Energy of Electrode Parts (Pads)

When the surface free energy of electrode parts (pad) was 65 dyne/cm to 150 dyne/cm, there was no disruption in energization for 60 min under all conditions: immediately after joining, after contact with ink, and after joining after retention in a substrate state for 72 h. Furthermore, the average electrostatic capacitance was maintained at 10 pF or higher. On the other hand, when the surface free energy was increased to 200 dyne/cm, the average electrostatic capacitance was below 10 pF immediately after joining, and furthermore, the energization was disrupted after contact with ink.

This is considered to be due to the fact that sufficient dispersion of the filler was not obtained in relation to the surface free energy of the filler.

Furthermore, the film thickness of the surfactant layer can change depending on the immersion time in the surfactant, and this film thickness is thought to affect the distance between the electrode parts of the liquid ejection chip and the electrode parts of the wiring substrate. It is believed that better electrical connection can be obtained when the film thickness is within the range described above.

In addition, where the surface free energy of not only the electrode parts but also of the substrate is within the range described above, the filler is more likely to be selectively positioned on the substrate, resulting in a better electrical connection.

### Surface Free Energy of Filler

When silicone fillers with a surface free energy of 24 dyne/cm or 55 dyne/cm were used as fillers, the energization was not disrupted for 60 min in all cases: immediately after joining, after contact with ink, and after joining after retention in a substrate state for 72 h. Furthermore, the average electrostatic capacitance was maintained at 10 pF or higher.

On the other hand, when a hydrophilic silica filler with a surface free energy of 60 dyne/cm was used, the average electrostatic capacitance was below 10 pF at a point in time immediately after joining, and furthermore, the energization was disrupted after contact with the liquid.

This is thought to be because when the surface free energy of the silicone filler is high, the repulsion between the filler and the hydrophilized electrode parts (pads) is reduced, causing the filler to accumulate and aggregate on the electrode parts (pads). It is thought that as a result of filler aggregation, the hydrophilic filler swells with ink during ink immersion, increasing the gaps between the electrode parts (pads), thereby causing a disruption in energization. Therefore, it is estimated that further hydrophilization of the filler would make it impossible to use the filler in an inkjet head.

For the reasons above, a smaller surface free energy of the silicone filler represents a more favorable condition. Comparing the cases of 24 dyne/cm and 55 dyne/cm, the former is considered to be a more favorable condition that actually results in the average electrostatic capacitance value exceeding 12 pF, which is higher than that obtained with the larger surface free energy. As mentioned earlier, since a more hydrophobic filler is preferable in the present embodiment, it is considered that there is no lower limit to the surface free energy of the filler.

### Ether Chain Length of Surfactant

Where the chain length of the ether part (number of repeating units of the ether structure) was in the range of 3 to 32, the energization was not disrupted for 60 min under all conditions examined: immediately after joining, after contact with ink, and after joining after retention in a substrate state for 72 h. Furthermore, the average electrostatic capacitance was maintained at 10 pF or higher. However, in the case of a chain length of 32, the electrostatic capacitance after contact with ink was in the range of 10 pF to 12 pF, that is, slightly lower than under other conditions. This is thought to be because the longer the chain length, the wider the gap between the electrode parts (pads) of the liquid ejection chip and the electrode parts (pads) of the wiring substrate, and the conduction weakens slightly when the ink enters and further widens the space. Therefore, an ether chain length in the range of 3 to 10 is estimated to be more preferable.

### Types of Surfactant

First, the structure of PEG-dimethicone examined in this study is shown in formula (A) above, and the structure of METOLOSE is shown in formula (B) above. In both cases, whether using PEG-dimethicone or METOLOSE, there was no disruption in energization for 60 min at all stages: immediately after joining, after contact with ink, and after joining after retention in a substrate state for 72 h. However, when comparing levels with different types of surfactants, such as Examples 2 and 8, and 4 and 9, it was confirmed that using PEG-dimethicone resulted in smaller decrease in electrostatic capacitance during contact with ink and retention for a long period of time.

This is thought to be because PEG-dimethicone has Si atoms in its main chain, resulting in a strong affinity with the metal surface and making it difficult for the bond to break. On the other hand, there considered to be two reasons for the decrease in electrostatic capacitance when using METOLOSE. First, it is believed that because METOLOSE does not have Si atoms, the bonds with the surface of electrode parts (pads) is weak, and some of the bonds may break due to ink or retention for a long period of time, making it easier for the surface free energy to decrease. It is considered that the other reason is that when METOLOSE was used, there was a tendency for the film thickness to be greater than when using PEG-dimethicone, and the distance between the electrode parts (pads) increased during contact with ink. This is thought to be due to the fact that since the bonds were originally weak, more molecules were needed to increase the surface free energy.

### Methods for Increasing Surface Free Energy

Methods for increasing the surface free energy of the electrode parts (pads) include not only modifying the surface with a surfactant but also using plasma to remove surface impurities and provide the inherent hydrophilicity of the metal. This time it was confirmed that in all cases, regardless of the method used, there was no disruption in energization for 60 min at all stages: immediately after joining, after contact with ink, and after joining after retention in a substrate state for 72 h.

However, upon adjustment performed to ensure the same surface free energy, it was confirmed that the method using a surfactant resulted in less decrease in electrostatic capacitance due to retention after modification. In the case of hydrophilization using plasma, a decrease in surface free energy was actually observed after 72 h of retention. It is generally known that this is due to the fact that hydrophilic groups exposed on the surface sink into the metal and that water molecules in the air contact the surface, thereby reducing hydrophilicity, and it is estimated that the same phenomenon is the cause in this case as well.

According to the present disclosure, it is possible to provide a liquid ejection unit that, when using an NCP material containing a filler, can suppress filler aggregation and achieve stable electrical connection, and also provide a method for manufacturing the liquid ejection unit.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-061182, filed Apr. 2, 2025, which is hereby incorporated by reference herein in its entirety.

What is claimed is:

1. A liquid ejection unit comprising a liquid ejection chip and a wiring substrate connected to the liquid ejection chip, wherein
the liquid ejection chip comprises:
an ejection element that generates energy for ejecting liquid;
a liquid ejection substrate on which the ejection element is provided; and
an electrode part provided on the liquid ejection substrate for driving the ejection element;
the wiring substrate is electrically connected to the electrode part;
the liquid ejection unit has a non-conductive adhesive that bonds the electrode part on the liquid ejection substrate and the wiring substrate;
the non-conductive adhesive contains a filler;
a surface free energy of the filler is 55 dyne/cm or less; and
a surface free energy of the electrode part is 65 to 150 dyne/cm.

2. The liquid ejection unit according to claim 1, wherein a surface free energy of the liquid ejection substrate is 70 dyne/cm or less.

3. The liquid ejection unit according to claim 1, wherein the electrode part is coated with a surfactant.

4. The liquid ejection unit according to claim 3, wherein the surfactant has Si in a main chain and has at least one functional group selected from the group consisting of —OH, —COOH, and —NH₃ at at least one terminal end.

5. The liquid ejection unit according to claim 3, wherein the surfactant contains a repeating unit having an ether structure, and the average number of the repeating units is 3 to 32.

6. The liquid ejection unit according to claim 3, wherein a coating layer of the surfactant on the electrode part has a film thickness of 1 to 150 nm.

7. A method for manufacturing a liquid ejection unit comprising a liquid ejection chip and a wiring substrate connected to the liquid ejection chip, wherein
the liquid ejection chip comprises:
an ejection element that generates energy for ejecting liquid;
a liquid ejection substrate on which the ejection element is provided; and
an electrode part provided on the liquid ejection substrate for driving the ejection element; and
the wiring substrate has electrode parts that can be electrically connected to the electrode parts of the liquid ejection chip;
the manufacturing method comprising:
a step of preparing the liquid ejection chip and the wiring substrate;
a step of hydrophilizing the electrode part at the liquid ejection chip; and
a step of bringing the hydrophilized electrode part at the liquid ejection chip into contact with the electrode part at the wiring substrate to enable electrical connection, and bonding the parts with a non-conductive adhesive to obtain the liquid ejection unit, wherein
the hydrophilizing step is a step of treating so that a surface free energy of the electrode part at the liquid ejection chip is 65 to 150 dyne/cm,
the non-conductive adhesive contains a filler, and
a surface free energy of the filler is 55 dyne/cm or less.
